(19) United States
(12) Patent Application Publication
(10) Pub. No.: US 2014/0033991 A1
(43) Pub. Date: Feb. 6, 2014

(54) Leash Latch

(71) Applicant: Hernan Almeida, Chicago, IL (US)

(72) Inventor: Hernan Almeida, Chicago, IL (US)

(21) Appl. No.: 13/564,163

(22) Filed: Aug. 1, 2012

(51) Int. Cl. B60R 22/10

(52) U.S. Cl. CPC B60R 22/10
USPC 119/771

(57) ABSTRACT

Leash Latch is an improvement to your everyday retractable pet leash. I have taken this standard design and attached a seatbelt tongue (male connector part) to the underside of the retractable leash allowing you to easily fastening the seatbelt tongue into any seatbelt buckle. Leash Latch makes it easy and practical to secure or release your pet from any seatbelt buckle by a simple click. This product also gives you the freedom to easily adjust the length of leash between the seatbelt buckle and your pet's collar by simply using the lock button on the retractable leash.

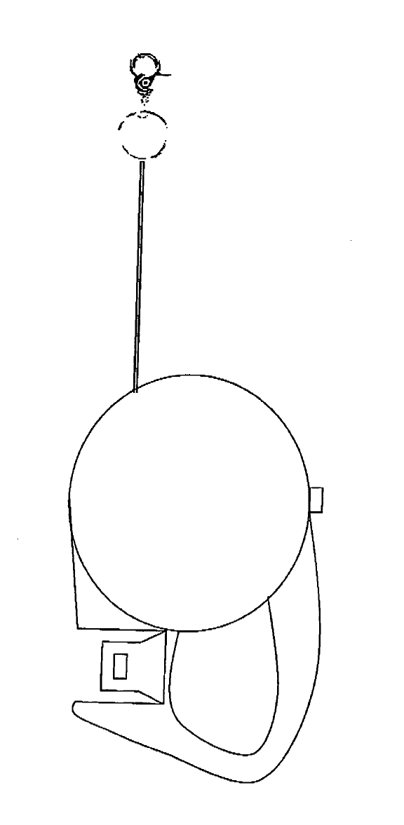

This design includes a standard retractable pet leash and a seatbelt tongue (male connector part), which is attached to the underside of the retractable leash unit. This design allows you to easily secure your pet to any seatbelt buckle in any vehicle and also adjust the length from the seatbelt buckle to the pets collar to a safe and comfortable distance by using the standard lock button on the retractable leash.

### DESCRIPTION OF DRAWING

This drawing shows a side view of a retractable pet leash with a seatbelt tongue (male connector) attached parallel with the unit on the underside, beneath the handle.

1. A retractable pet leash that has the ability to connect to any vehicle seatbelt buckle (female connector part).

2. The method of claim 1, wherein the retractable pet leash has an attached seatbelt tongue (male connector part).

3. The method of claim 1, wherein the attached seatbelt tongue will secure to any vehicle seatbelt buckle.
